(19) United States
(12) Patent Application Publication
(10) Pub. No.: US 2008/0290185 A1
(43) Pub. Date: Nov. 27, 2008

(54) Method of dispensing fluid sprayed by a piezoelectric sprayer system, and sprayer system for implementing such a method

(76) Inventor: Nicolas Duru, Paris (FR)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 12/004,058

(22) Filed: Dec. 20, 2007

Related U.S. Application Data
(60) Provisional application No. 60/885,571, filed on Jan. 18, 2007.

(30) Foreign Application Priority Data
Jan. 18, 2007 (FR) 06/55745

(51) Int. Cl. B05B 17/00

(52) U.S. Cl. 239/4; 239/102.2

(57) ABSTRACT

A method for dispensing fluid, including flowing fluid from at least one reservoir to a fluid feed chamber of a piezoelectric sprayer device during a spray cycle, and at an end portion of the spray cycle, reversing the direction of flow of the fluid such that the fluid is substantially removed from the fluid feed chamber.

This application claims priority under 35 U.S.C. § 119 to U.S. Provisional Application No. 60/885,571, filed Jan. 18, 2007. This application also claims benefit of priority under 35 U.S.C. § 119 to French Patent Application No. 06 55745, filed Dec. 20, 2006.

The present disclosure relates to a piezoelectric sprayer system and to a method of dispensing at least one fluid sprayed via such a system.

### BACKGROUND

Piezoelectric sprayer devices have generally been used for spraying various fluids of low viscosity (e.g., room fragrances). In such sprayer devices, a wick or other device may act via capillarity to feed a fluid to a diaphragm that is set into vibration, resulting in atomization of the fluid. However, such devices have not been suitable for spraying fluids that are more viscous, such as certain cosmetic products (e.g., foundation makeup, tanning solutions, etc.).

International Patent Application No. WO 2005/075095 discloses an electrostatic sprayer system including a pump for feeding a sprayer end-piece, within which the fluid is subjected to an electric field. However, such a sprayer system presents at least the drawback that it requires a special formulation for the fluid to make it suitable for being polarized and dispersed under the effect of the electric field.

The present disclosure may address some or all of these problems.

### SUMMARY

In the following description, certain aspects and embodiments will become evident. It should be understood that the invention, in its broadest sense, could be practiced without having one or more features of these aspects and embodiments. It should be understood that these aspects and embodiments are merely exemplary.

In one exemplary aspect, a method for dispensing fluid is disclosed. The method may include flowing fluid from at least one reservoir to a fluid feed chamber of a piezoelectric sprayer device during a spray cycle, and at an end portion of the spray cycle (e.g., at an end of the spray cycle or at some time prior to the end), reversing the direction of flow of the fluid such that the fluid is substantially removed from the fluid feed chamber.

In another exemplary aspect, a fluid sprayer system is disclosed. The fluid sprayer system may include a reservoir containing at least one fluid to be sprayed, a fluid feed chamber for feeding a piezoelectric sprayer device, and a flow inducer configured to induce the at least one fluid to flow from the reservoir to the fluid feed chamber during a spray cycle. The fluid sprayer system may further include a controller configured to control the flow inducer to reverse a direction of flow of the fluid at an end portion of the spray cycle such that the fluid is substantially removed from the fluid feed chamber.

In yet another exemplary aspect, a method for dispensing a cosmetic product is disclosed. The method may include actuating a piezoelectric sprayer including a fluid feed chamber, inducing, via a pump, a flow of a cosmetic product from at least one reservoir to the fluid feed chamber of the piezoelectric sprayer, reversing the direction of flow of the cosmetic product such that the cosmetic product is substantially removed from the fluid feed chamber, and terminating actuation of the piezoelectric sprayer.

The fluid feed chamber may be defined at least in part by a vibrating diaphragm of the piezoelectric device. The use of a piezoelectric device may enable the resulting spray to be relatively broad.

In some embodiments, the fluid may be induced to flow by a pump that may be driven in one direction to feed the fluid feed chamber and in a substantially opposite direction to empty the fluid feed chamber.

In some embodiments, the pump may comprise two rotary members, e.g. of oval or other shape, optionally including sets of teeth. The two rotary members may rotate in contact with each other, and in the absence of teeth associated with the rotary members, means may be provided to ensure that one rotary member does not slide relative to the other (e.g., friction or other suitable mechanical connection).

Further, the pump may be configured so that when not in operation, communication between the fluid feed chamber and the reservoir may be substantially terminated. Such termination of fluid communication may contribute to conservation of the fluid, particularly if the fluid includes one or more volatile solvents.

In some embodiments, operation of the piezoelectric sprayer device may be interrupted after the flow of fluid has been reversed. For example, operation of the piezoelectric device may continue for a length of time that may be greater than or equal to 0.5 second (s) following the reversal of the fluid flow direction. In another example, the duration may lie in a range of 0.5 s to 2 s. This may further improve emptying of the fluid feed chamber by spraying a quantity of residual fluid.

In some embodiments, the piezoelectric sprayer device may operate before the fluid is provided to the fluid feed chamber and may be caused to operate at the beginning of a spray cycle. This can improve the distribution of the sprayed fluid by enabling the piezoelectric device to reach a relatively stable operating speed before beginning to spray.

In some embodiments, the fluid feed chamber may be fed with at least one fluid via a conduit located at a position associated with a bottom portion of the fluid feed chamber when the piezoelectric sprayer device is in a substantially upright position.

In some embodiments, an inclination of the fluid feed chamber may be determined. Information associated with this determination can be used to inform the user when the sprayer system has an orientation that may not be suitable for emptying the fluid feed chamber. An audible and/or visual signal can also be emitted to alert the user.

The length of time the fluid flows towards the fluid feed chamber can be measured. An audible and/or visual signal may be emitted as a function of the length of time the fluid has been flowing to inform the user about the degree to which the reservoir has been emptied.

In some embodiments, the fluid feed chamber may receive fluid for spraying from at least two reservoirs. In such embodiments, the fluids may be different (e.g., two fluids of different colors) or the fluids may be the same. Further, the fluid(s) may be drawn from the reservoir(s) without any intake of air.

The fluid feed chamber may have an associated volume of less than or equal to 1 milliliter (mL). In one example, a volume associated with the fluid feed chamber may lie in a range of 0.25 mL to 0.75 mL. Further, a mass rate of flow of the fluid to the fluid feed chamber during spraying may lie in a range of 0.1 grams per minute (g/min) to 5 g/min. In one example, a mass rate of fluid flow to the fluid feed chamber may lie in a range of 0.7 g/min to 0.9 g/min.

In some embodiments, the fluid may include any cosmetic or care product, for example, a makeup composition, in particular a foundation or a self-tanning composition.

In some embodiments, a flow inducer may include a pump secured to the reservoir. In such an embodiment, the pump and reservoir assembly may be included within a refill for the device. Further, the sprayer system may include a switch (e.g., a pushbutton) configured to trigger a spray cycle.

In some embodiments, the sprayer system may include a motor configured to drive a first coupling member, and the system may also include a second coupling member operatively connected to the pump and the first coupling member such that rotation of the first coupling member causes a rotation of the second coupling member resulting in operation of the pump.

The piezoelectric sprayer device may be separable from the reservoir, or in some embodiments it may be configured to remain affixed to the reservoir.

Utilizing exemplary systems and methods of the present disclosure, a fluid, including relatively viscous fluids, may be sprayed by the piezoelectric sprayer device. Further, exemplary systems and methods of the present disclosure may reduce and/or substantially prevent drying of the fluid within the fluid feed chamber, and therefore reduce and/or substantially prevent significant solid accumulation between operations of the device separated by intervals of time.

### BRIEF DESCRIPTION OF THE DRAWINGS

The accompanying drawings, which are incorporated in and constitute a part of this specification, illustrate a number of exemplary features of non-limiting embodiments of the invention and together with the description, serve to explain the principles of the invention. In the drawings,

FIG. 1 is a perspective view of an exemplary sprayer system consistent with one embodiment of the present disclosure;

FIG. 2 shows an exemplary refill associated with the sprayer system of FIG. 1;

FIG. 3 is a profile view highlighting the area indicated by the arrow III of FIG. 2;

FIG. 4 is a rear view highlighting the area indicated by the arrow IV of FIG. 3;

FIG. 5 is a diagram showing an exemplary flow inducer according to some embodiments of the invention;

FIG. 6 is a diagram showing an exemplary fluid feed chamber of a piezoelectric device and an exemplary pump associated with the exemplary fluid feed chamber;

FIG. 7 is a block diagram showing exemplary components of the sprayer system;

FIG. 8 is a cross-section view of another exemplary flow inducer according to another embodiment of the disclosure;

FIG. 9 is a perspective view of a section of a sprayer system consistent with embodiments of the current disclosure;

FIG. 10 is a perspective view of a section of another sprayer system consistent with embodiments of the current disclosure; and

FIG. 11 is a block diagram showing an exemplary sequence of a spray cycle.

### DESCRIPTION

Reference will now be made in detail to exemplary embodiments of the invention, examples of which are illustrated in the accompanying drawings. Wherever possible, the same reference numbers will be used throughout the drawings to refer to the same or like parts. It is to be understood that both the foregoing general description and the following detailed description are exemplary and explanatory only and are not restrictive of the invention, as claimed.

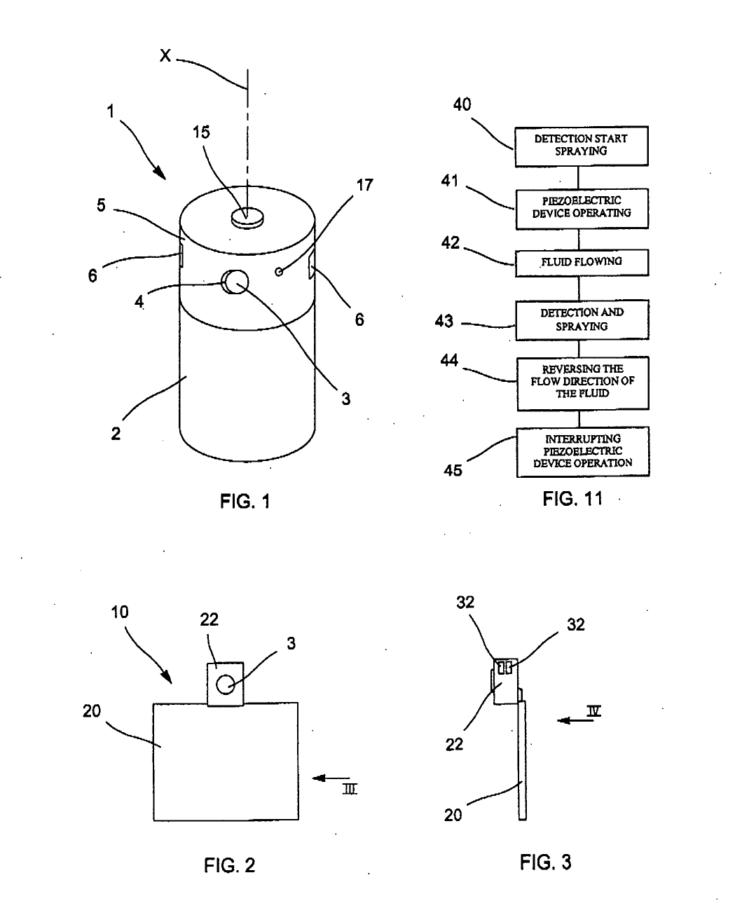

A sprayer system 1 shown in FIG. 1 may include a housing 2 containing a piezoelectric sprayer device 3, which may enable a fluid to be sprayed through an opening 4 of the housing 2. For example, opening 4 may be a front opening with an axis extending perpendicularly to the longitudinal axis X of housing 2, as shown in FIG. 1. In such an example, opening 4 may be formed in a removable cap 5, which can be separated from the base of the housing by acting on unlocking tabs 6 (e.g., diametrically opposite tabs). Removing cap 5 may allow access to a refill 10 similar to that shown in FIGS. 2 to 4. Other embodiments and configurations associated with housing 2 are possible and intended to fall within the scope of the present disclosure.

As shown diagrammatically in FIG. 7, sprayer system 1 may include a power source 11 (e.g., one or more batteries or other electrical source), which may be accessible under cap 5 and/or by removing a cover (not shown) to enable replacement of the power source. In some embodiments, power source 11 may be integrated within refill 10.

Sprayer system 1 also may include a controller 12 that may control the operation of an electric motor 13 and the operation of piezoelectric sprayer device 3 during a spray cycle, as described in detail below.

In some exemplary embodiments, sprayer system 1 may include a pushbutton 15, which may be situated in a top portion of housing 2. Pushbutton 15 may pass through a corresponding opening formed in cap 5. Alternatively, pushbutton 15 may be located at any suitable position on housing 2 (e.g., a side portion of housing 2 or cap 5).

Sprayer system 1 also may include at least one visual alarm 17 (e.g., including a light-emitting diode (LED)) and/or an audible alarm (not shown) (e.g., including a speaker)), and may include at least one inclinometer 19 shown diagrammatically in FIG. 7. For example, a visual alarm 17 may include an LED that changes color or that flashes when the reservoir 20 is empty or nearly empty. Visual alarm 17 can also be actuated to indicate that the device is operating properly. Audible alarm may be configured to emit an audible warning (e.g., play a sound file and/or emit a “beep”). One of skill in the art will recognize that other variations on alarms may be implemented without departing from the scope of the present invention.

As shown in FIG. 2, refill 10 may include a reservoir 20, for example, in the form of a flexible pouch containing at least one fluid for dispensing. The fluid can be taken from the reservoir 20 without any air intake, where desired. In such an embodiment, refill 10 further may include piezoelectric sprayer device 3, which may be contained in a housing 22 secured to the reservoir 20.

Piezoelectric sprayer device 3 may include a ring (not shown) made of piezoelectric material, and a perforated diaphragm, sometimes also referred to as a grid, that may be mechanically driven to vibrate by the ring. The ring may be circular or non-circular in shape, and may include a ceramic such as, for example, a zirconate (PZT), metaniobate (PN), barium titanate, and/or zinc oxide. French Patent Application No. FR 2 886 174 discloses an example of a piezoelectric sprayer device that may be implemented with systems and methods of the present disclosure.

The perforated diaphragm may have a diameter greater than or equal to 6 millimeters (mm), and in some cases may be equal to 7 mm. Further, the diaphragm may have more than 100 perforations, and in one embodiment may have 150 perforations. Further the perforations may have a diameter lying in a range of 20 micrometers (μm) to 40 μm, and in one embodiment may have a diameter equal to approximately 30 μm. Moreover, the perforations may be situated in a central region of the diaphragm. One of ordinary skill in the art will recognize that desired diameter and locations associated with the perforations may vary slightly in any particular implementation without departing from the scope of the present disclosure.

According to some embodiments of the present disclosure, the diaphragm may be adhesively or otherwise bonded onto a piece of the ring having thickness lying in a range of 0.5 mm to 0.7 mm. In one example, a thickness associated with the ring may be approximately 0.6 mm, with an outside diameter that is approximately equal to 20 mm and an inside diameter that is approximately equal to 5 mm.

Controller 12 may be configured to deliver an excitation current to the ring of piezoelectric material and may include electronic components enabling such excitation at a resonant frequency associated with the ring. For example, the ring may be excited, by a sinusoidal voltage at 100 kilohertz (kHz) with a peak-to-peak amplitude of 100 millivolts (mV). One of ordinary skill in the art will recognize that different sizes and materials may be associated with different resonant properties. Therefore, any such variations are intended to fall within the scope of the present disclosure.

Reservoir 20 can be connected to housing 22 in a detachable manner, for example, where it is desirable to allow replenishment of a fluid while conserving the piezoelectric sprayer device 3. Alternatively when configured to remain affixed to housing 2, reservoir 20 may be configured to be refilled with fluid. For example, reservoir 20 may include an opening for providing additional fluid to reservoir 20.

Housing 22 may also include a flow inducer 26 (e.g., a rotary pump) that may be configured to cause the fluid to flow from the reservoir 20 towards a fluid feed chamber 27 for feeding the piezoelectric sprayer device 3. Alternatively, flow inducer 26 may be contained within reservoir 20, or any other suitable location associated with sprayer system 1.

Fluid feed chamber 27 may be defined on one side by the vibrating diaphragm of piezoelectric sprayer device 3. In one example, flow inducer 26 may include two rotary members 28 and 29 that may rotate in contact with each other. Such a configuration may enable a termination of fluid communication between fluid feed chamber 27 and reservoir 20 while flow inducer 26 is at rest (i.e., not operating). Fluid feed chamber 27 may be fed by a conduit 48 located at a position associated with a bottom portion of fluid feed chamber 27 when the piezoelectric sprayer device is in a substantially upright position. Conduit 48 may be of small cross section and may be in fluid communication with flow inducer 26 and reservoir 20.

Piezoelectric sprayer device 3 may be manufactured to various specifications, for example the vibrating diaphragm may include any shape. Therefore, the present disclosure is not limited to a piezoelectric sprayer device having any particular shape. Further, the shape of fluid feed chamber 27 may depend on the shape of the vibrating diaphragm associated with piezoelectric sprayer device 3. For example, in one embodiment, piezoelectric sprayer device 3 can include a shape similar to that disclosed in International Patent Application No. WO 91/16997.

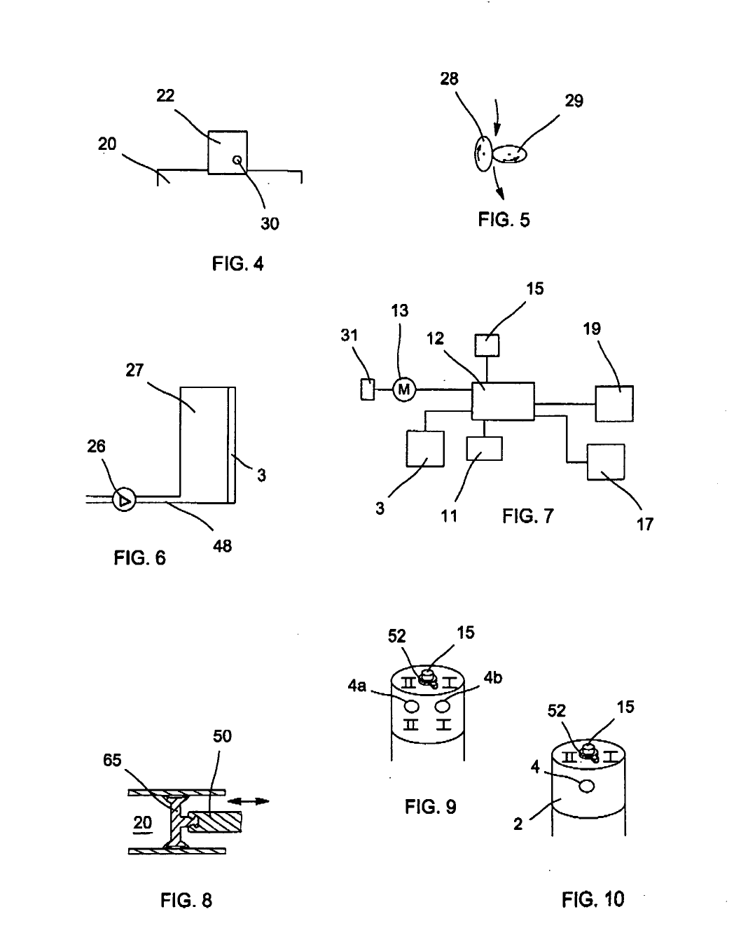

Flow inducer 26 may be driven by a second coupling member 30 that may be accessible from one of the faces of the housing 22 as shown in FIG. 4. First coupling member 31 may be configured to be driven by the motor 13 as shown diagrammatically in FIG. 7. Further first coupling member 31 may be arranged to co-operate with second coupling member 30 resulting in transmission of rotation from motor 13 via first and second coupling members 31 and 30 to rotary members 28 and 29, thereby actuating flow inducer 26. Step-down gearing between motor 13 and first coupling member 31 may be implemented as desired (e.g., where a viscous fluid is used).

Housing 22 also may include power transmission elements 32 (e.g., electrical conductors) configured to provide power to piezoelectric sprayer device 3. Housing 2 may contain corresponding power transmission elements connected to controller 12 for purposes of receiving power. Therefore, power transmission elements 32 may be powered by controller 12 while refill 20 is present in housing 2. Motor 13 may then be provided power by controller 12, thereby causing first and second coupling members 31 and 30 to co-operate resulting in actuation of flow inducer 26.

Inclinometer 19 may be used to sense an inclination associated with sprayer system 1. Inclinometer 19 may provide controller 12 with information related to the inclination associated with sprayer system 1. Controller 12 may be arranged to inform the user, for example, by actuating visual alarm 17 or audible alarm (not shown), that sprayer system 1 is not in the best orientation for emptying fluid feed chamber 27, and that it could be placed more upright as shown in FIG. 6.

Where appropriate, controller 12 can also monitor the length of time motor 13 operates while driving flow inducer 26 to deliver fluid to fluid feed chamber 27. This operating time can then be compared with a predefined value, and controller 12 can be arranged to warn the user that the reservoir is about to be emptied, e.g. by emitting a sound and/or light signal.

FIG. 11 is a block diagram showing an exemplary sequence of a spray cycle. Actuation of pushbutton 15 may be detected by controller 12 (step 40). Controller 12 may then cause piezoelectric sprayer device 3 to operate (step 41), and subsequently provide power to motor 13 so as to cause the fluid to flow towards the fluid feed chamber 27 (step 42).

Spraying of the fluid may take place so long as the user continues to depress the pushbutton 15, or alternatively, a predetermined spraying duration may be stored in controller 12 and used for automatically terminating spraying. When release of the pushbutton is detected, piezoelectric sprayer device 3 may continue to operate while a direction of rotation associated with motor 13 is reversed (step 43). This may cause flow inducer 26 to reverse a flow direction associated with the fluid, thereby substantially emptying fluid feed chamber 27. After a predetermined duration, operation of piezoelectric sprayer device 3 may be stopped (step 45).

The present disclosure is not limited to one particular drive means for causing the fluid to flow towards the fluid feed chamber 27 from the reservoir 20 or in the opposite direction, and various types of flow inducers 26 can be used. For example, it may be possible to use a peristaltic pump, a gear pump, and/or a screw pump, among other things.

Reservoir 20 can also be defined at least in part by a piston 65, as shown in FIG. 8, and motor 13 can serve to drive a pusher 50 that enables the piston 65 to be moved in one direction or the other, depending on whether it is desired to feed the fluid feed chamber 27 or to empty it.

It is not intended that the present disclosure be limited to spraying a single fluid. For example, housing 2 may receive at least two refills, which each may be associated with a respective piezoelectric sprayer device 3. In such an embodiment, housing 2 may include two openings 4a and 4b for spraying each of the two fluids, as shown in FIG. 9. Alternatively, the at least two refills may be associated with a single piezoelectric sprayer device 3 and single opening 4 in housing 2 (as shown in FIG. 10).

Sprayer system 1 may further include a selector 52 that may enable a user to select one or more of the fluids, to be sprayed individually or simultaneously at a ratio determined by the user. In such an example, controller 12 may control respective motors 13 driving associated flow inducers 26 at different speeds of rotation, depending on, for example, a function of the relative proportions of the fluid that are to be delivered. In such an embodiment, sprayer system 1 may include two or more reservoirs, each containing a fluid for spraying. Corresponding flow inducers 26 may then both feed a single fluid feed chamber 27 associated with piezoelectric sprayer device 3.

In some embodiments consistent with the present disclosure, refill 10 may also include motor 13. In such an embodiment, additional power transmission elements 32 may be provided at a suitable location on refill 10 to enable refill 10 to be supplied with power (e.g., electricity) for driving motor 13. Alternatively, sprayer system 1 may include a refill 10 comprising no more than reservoir 20.

In other embodiments, sprayer system 1 may not have a removable refill 10. In such an embodiment, reservoir 20 may be configured to be affixed to housing 2 of sprayer system 1, and may be capable of being refilled with fluid. Flow inducer 26, used for delivering fluid to fluid feed chamber 27 of piezoelectric sprayer device 3 may also be used for filling reservoir 20. For example, a selector may be provided allowing flow inducer 26 to draw fluid from a source configured to fill reservoir 20. Further, refill 10 may include means for informing housing 2 and or controller 12 about the nature of the fluid contained. For example, contacts associated with refill 10 may cooperate with contacts in housing 2, and a state associated with the contacts (e.g., an electrical signal conveyed by the contacts) may then be analyzed by controller 12.

Refill 10 also may include an electronic memory and/or a bar code that may store information related to the fluid contained inside it (e.g., identity of fluid, fluid spray conditions, quantity of fluid, rate at which piezoelectric sprayer device 3 should be fed, etc).

Throughout this disclosure, the term “comprising a” should be understood as being synonymous with “comprising at least one” unless specified to the contrary. In addition, any range set forth in the description, including the claims should be understood as including its end value(s).

Further, although the present disclosure herein has been described with reference to particular embodiments, it is to be understood that these embodiments are merely illustrative of the principles and applications of the present disclosure. It is therefore to be understood that numerous modifications may be made to the illustrative embodiments and that other arrangements may be devised without departing from the present disclosure.

What is claimed is:

1. A method for dispensing fluid, comprising:
flowing fluid from at least one reservoir to a fluid feed chamber of a piezoelectric sprayer device during a spray cycle; and
at an end portion of the spray cycle, reversing the direction of flow of the fluid such that the fluid is substantially removed from the fluid feed chamber.

2. The method according to claim 1, wherein the flowing comprises operating a pump driven in a first direction, and wherein the reversing comprises operating the pump driven in a second direction substantially opposite to the first direction.

3. The method according to claim 2, wherein the pump comprises two rotary members.

4. The method according to claim 2, wherein the pump, when stopped, substantially terminates fluid communication between the fluid feed chamber and the reservoir.

5. The method according to claim 1, further comprising interrupting operation of the piezoelectric sprayer device after the initiation of the reversing.

6. The method according to claim 5, wherein the piezoelectric sprayer device operates for a duration greater than or equal to 0.5 second after initiation of the reversing.

7. The method according to claim 6, wherein the duration lies in the range of 0.5 second to 2 seconds.

8. The method according to claim 1, further comprising operating the piezoelectric sprayer device before the fluid is caused to flow at the beginning of the spray cycle.

9. The method according to claim 1, further comprising determining an inclination associated with the fluid feed chamber.

10. The method according to claim 9, further comprising emitting at least one of an audible and a visible signal when the fluid feed chamber has an inclination that is unfavorable for emptying.

11. The method according to claim 1, further comprising measuring a duration associated with the flow of fluid to the fluid feed chamber.

12. The method according to claim 11, further comprising emitting at least one of an audible and a visible signal based on the duration.

13. The method according to claim 1, wherein the fluid feed chamber receives one or more fluids from at least two reservoirs.

14. The method according to claim 1, wherein the piezoelectric sprayer device comprises a vibrating diaphragm.

15. The method according to claim 1, wherein the fluid is drawn from the reservoir without intake of air.

16. The method according to claim 1, wherein the fluid feed chamber is fed with at least one fluid via a conduit located at a position associated with a bottom portion of the fluid feed chamber when the piezoelectric sprayer device is in a substantially upright position.

17. The method according to claim 1, wherein a volume of the fluid feed chamber is less than or equal to 1 mL.

18. The method according to claim 1, wherein a mass rate of fluid flow to the fluid feed chamber during a spray cycle lies in a range of 0.1 g/minute to 5 g/minute.

19. The method according to claim 18, wherein the mass rate of fluid flow lies in a range of 0.7 g/minute to 0.9 g/minute.

20. The method according to claim 1, wherein the fluid includes at least one of a cosmetic, a perfume, and a care product.

21. The method according to claim 20, wherein the fluid includes a foundation makeup composition.

22. A method according to claim 20, wherein the fluid includes a tanning composition.

23. A fluid sprayer system comprising:
a reservoir containing at least one fluid to be sprayed;
a fluid feed chamber for feeding a piezoelectric sprayer device;
a flow inducer configured to induce the at least one fluid to flow from the reservoir to the fluid feed chamber during a spray cycle; and
a controller configured to control the flow inducer to reverse a direction of flow of the fluid at an end portion of the spray cycle such that the fluid is substantially removed from the fluid feed chamber.

24. The system according to claim 23, further including a switch for triggering the spray cycle.

25. The system according to claim 23, wherein the flow inducer comprises a pump.

26. The system according to claim 25, wherein the pump is substantially affixed to the reservoir.

27. The system according to claim 25, further including a motor configured to drive a first coupling member;
a second coupling member operatively connected to the pump and the first coupling member such that rotation of the first coupling member causes a rotation of the second coupling member resulting in operation of the pump.

28. The system according to claim 23, wherein the piezoelectric sprayer device is separable from the reservoir.

29. The system according to claim 23, wherein the piezoelectric sprayer device is configured to remain affixed to the reservoir.

30. A method for dispensing a cosmetic product, comprising:
actuating a piezoelectric sprayer including a fluid feed chamber;
inducing, via a pump, a flow of a cosmetic product from at least one reservoir to the fluid feed chamber of the piezoelectric sprayer;
reversing the direction of flow of the cosmetic product such that the cosmetic product is substantially removed from the fluid feed chamber; and
terminating actuation of the piezoelectric sprayer.

31. The method of claim 30, wherein the pump is a rotary pump.

32. The method of claim 30, wherein the cosmetic product includes at least one of a tanning solution and a foundation.
